(19) United States
(12) Patent Application Publication
(10) Pub. No.: US 2024/0175826 A1
(43) Pub. Date: May 30, 2024

(54) WAFER DEFECT INSPECTION APPARATUS

(71) Applicant: PlayNitride Display Co., Ltd., MiaoLi County (TW)

(72) Inventors: Yi-Chia Hwang, MiaoLi County (TW); Ching-Liang Lin, MiaoLi County (TW)

(73) Assignee: PlayNitride Display Co., Ltd., MiaoLi County (TW)

(21) Appl. No.: 18/082,562

(22) Filed: Dec. 15, 2022

(30) Foreign Application Priority Data
Nov. 29, 2022 (TW) 111145541
Nov. 29, 2022 (TW) 111145542

(51) Int. Cl. G01N 21/95

(52) U.S. Cl. CPC G01N 21/9505; G01N 2201/0636

(57) ABSTRACT

A wafer defect inspection apparatus including a carrier base, a light source module, a beam splitter, filters and image sensors are provided. The carrier base carries a sample to be tested. The light source module includes an illuminating unit and a pellicle mirror. The illuminating unit emits an inspection light ray. A reflective surface is capable of reflecting the inspection light ray to the sample to be tested, so that a reflective light ray formed by reflecting the inspection light ray reflected by the sample to be tested passes through the pellicle mirror and is then split into splitting light rays by the beam splitter. The filters are configured to be passed through by different bands corresponding to the splitting light rays. The image sensors receive the splitting light rays to generate imaging frames. Two corresponding positions in any two of the imaging frames have two different contrast ratios.

### CROSS-REFERENCE TO RELATED APPLICATION

This application claims the priority benefit of Taiwan application serial no. 111145541, filed on Nov. 29, 2022, and Taiwan application serial no. 111145542, filed on Nov. 29, 2022. The entirety of each of the above-mentioned patent applications is hereby incorporated by reference herein and made a part of this specification.

### BACKGROUND

### Technical Field

The disclosure relates to a wafer defect inspection apparatus, and more particularly, to a wafer defect inspection apparatus with high inspection efficiency.

### Description of Related Art

Nowadays, it is quite common to use automated optical inspection (AOI) to determine whether the sample to be tested is good or not. In general, there will be multiple target features on the sample to be tested that need to be confirmed whether they meet the standards. Corresponding to inspection light rays of different bands, the contrast ratio of the target features of the same position on the sample to be tested also changes. Thus, selecting appropriate bands for different target features and topographies helps improve the contrast ratio of the imaging frame, so as to more clearly determine whether the target features corresponding to each position meet the standards.

However, in order to obtain better inspection quality by using this method, it is conventional to inspect the sample to be tested by using light rays of multiple bands to obtain a high contrast ratio image of each of the target features. Therefore, as the amount of inspected topographies increases, the inspection time will increase exponentially, resulting in a decrease in the efficiency of automatic optical inspection.

### SUMMARY

The disclosure provides a wafer defect inspection apparatus, which receives imaging frames generated by light rays of different bands through a single inspection, thereby improving inspection efficiency.

The wafer defect inspection apparatus of the disclosure is adapted for inspecting a sample to be tested, which includes a carrier base, a light source module, at least one beam splitter, multiple filters, and multiple image sensors. The carrier base adapted for carrying the sample to be tested. The light source module is disposed corresponding to the carrier base. The light source module includes an illuminating unit and a pellicle mirror. The illuminating unit is configured to emit an inspection light ray. The pellicle mirror includes a reflective surface. The reflective surface faces the illuminating unit and the carrier base. The reflective surface is adapted for reflecting the inspection light ray to the sample to be tested, so that a reflective light ray formed by reflecting the inspection light ray reflected by the sample to be tested passes through the pellicle mirror. The at least one beam splitter is disposed on one side of the pellicle mirror opposite to the carrier base and configured to receive and split the reflective light ray passing through the pellicle mirror into multiple splitting light rays. Multiple filters are respectively disposed on light pathways of the splitting light rays. The filters are configured to be passed through by different bands corresponding to the splitting light rays. The multiple image sensors are disposed on the light pathways of the splitting light rays and respectively located on one side of one of the filters opposites to the beam splitter. Each of the image sensors receives one of the splitting light rays to generate an imaging frame, and two corresponding positions in any two of the imaging frames have two different contrast ratios.

### BRIEF DESCRIPTION OF THE DRAWINGS

FIG. 1 is a schematic view of a wafer defect inspection apparatus according to an embodiment of the disclosure.

FIG. 2A is a schematic top view of a sample to be tested.

FIG. 2B is a microscope image of position A captured by one of the image sensors.

FIG. 2C is a microscopic image of position A captured by another image sensor.

FIG. 2D is a microscope image of position B captured by one of the image sensors.

FIG. 2E is a microscope image of position B captured by another image sensor.

FIG. 3 is a schematic view of a wafer defect inspection apparatus according to another embodiment of the disclosure.

FIG. 4 is a schematic view of a wafer defect inspection apparatus according to another embodiment of the disclosure.

### DESCRIPTION OF THE EMBODIMENTS

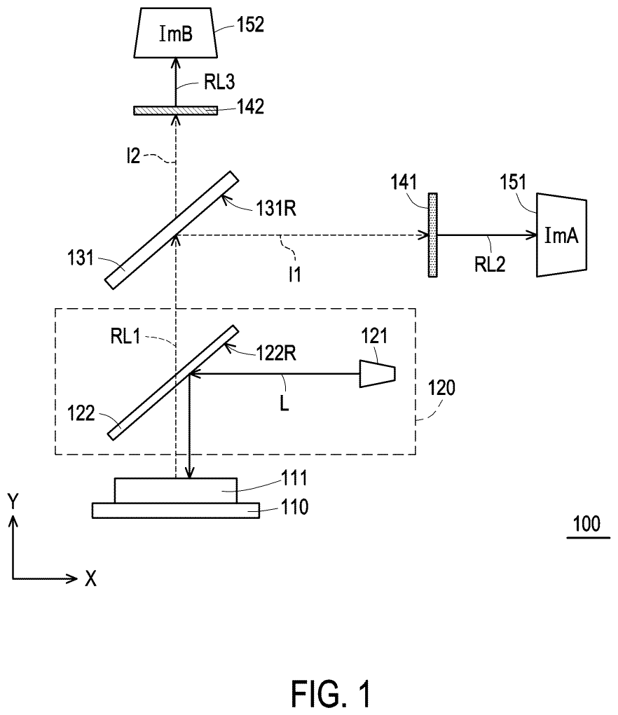

FIG. 1 is a schematic view of a wafer defect inspection apparatus according to an embodiment of the disclosure. Referring to FIG. 1, where Cartesian coordinates XY are provided to facilitate the description of subsequent components.

As shown in FIG. 1, in this embodiment, a wafer defect inspection apparatus 100 includes a carrier base 110, a light source module 120, a beam splitter 131, a filter 141, a filter 142, and two image sensors 151 and 152. The carrier base 110 is adapted for carrying a sample to be tested 111. In some embodiments, the sample to be tested 111 is, for example, a semiconductor wafer, but not limited thereto. The light source module 120 is disposed corresponding to the carrier base 110 and includes an illuminating unit 121 and a pellicle mirror 122.

The illuminating unit 121 emits an inspection light ray L. and the spectrum of the inspection light ray may be a continuous spectrum. For example, in some embodiments, the spectrum of the inspection light ray L may include at least two of the following bands: ultraviolet light (wavelength range of about 100 nm to 380 nm), violet light (wavelength range of about 380 nm to 450 nm), blue light (wavelength range of about 450 nm to 495 nm), green light (wavelength range of about 495 nm to 570 nm), yellow light (wavelength range of about 570 nm to 590 nm), orange light (wavelength range of about 590 nm to 620 nm), red (wavelength range of about 620 nm to 750 nm), and infrared light (wavelength range of about 750 nm to 1 mm).

For example, in this embodiment, the inspection light ray L includes a red light band (wavelength range of about 620 nm to 750 nm) and a blue light band (wavelength range of about 450 nm to 495 nm), but not limited thereto.

In some embodiments, the illuminating unit 121 may include, for example, xenon lamps, mercury lamps, or tungsten filament lamps of multiple light bands. In some embodiments, the illuminating unit 121 may include a light emitting diode chip and a wavelength conversion material. The wavelength conversion material is configured on the light emitting diode chip to provide light of different bands. The light emitting diode chip may be a blue-light light emitting diode chip, and the wavelength conversion material may be a green phosphor layer, a yellow phosphor layer, or a red phosphor layer, but the disclosure is not limited thereto.

In this embodiment, the pellicle mirror 122 is configured to allow some of the light to be reflected and some of the light to pass through. Specifically, the pellicle mirror 122 is disposed opposite to the illuminating unit 121 and located on the light pathway of the inspection light ray L. A reflective surface 122R of the pellicle mirror 122 faces the illuminating unit 121 and the carrier base 110, and is configured to reflect the inspection light ray L to an observation surface on the sample to be tested 111. The illuminating unit 121 and the sample to be tested 111 are on the same side of the pellicle mirror 122, and the reflective surface 122R is configured to change the direction of the inspection light ray L.

In this embodiment, the direction of the inspection light ray L emitted by the illuminating unit 121 is, for example, a direction parallel to the X axis. The direction of the inspection light ray L reflected by the reflective surface 122R is a direction parallel to the Y axis (−Y). The reflective light ray RL1 reflected by the sample to be tested 111 is parallel to the Y axis (+Y) direction. Thus, the inspection light ray L reflected by the reflective surface 122R and the reflective light ray RL1 reflected by the sample to be tested 111 are two parallel light rays.

In some embodiments, the sample to be tested 111 may include multiple observation surfaces. The reflective light ray RL1 reflected by the sample to be tested 111 may include height information or topographic information of these observation surfaces.

In this embodiment, the reflective light ray RL1 reflected by the sample to be tested 111 passes through the pellicle mirror 122, and the reflective light ray RL1 transmitted and the inspection light ray L emitted by the illuminating unit 121 may include the same light bands. That is, the pellicle mirror 122 does not have a band filtering function.

The beam splitter 131 is disposed on a side of the pellicle mirror 122 opposite to the carrier base 110. The beam splitter 131 is configured to split the reflective light ray RL1 into splitting light rays I1 and splitting light rays 12. In some embodiments, the reflectivity of the beam splitter 131 may include, for example, ½, ⅓, or ¼. This means that ½, ⅓, or ¼ of the light rays entering the beam splitter 131 is reflected to other directions, and the remaining light rays passes through the beam splitter 131.

More specifically, in this embodiment, the reflectivity of the beam splitter 131 is, for example, ½. In response to the reflective light ray RL1 being directed to the beam splitter 131, half of the reflective light ray RL1 is reflected by the reflective surface 131R of the beam splitter 131, and another half of the reflective light ray RL1 passes through the beam splitter 131. The reflective light ray RL1 may be equally divided into two splitting light rays, the light intensity of each of the two splitting light rays is about half that of the reflective light ray RL1, and has the same light bands as the reflective light ray RL1.

In this embodiment, an included angle between the reflective surface 131R of the beam splitter 131 and the light pathway of the reflective light ray RL1 is, for example, 45 degrees. The reflective light ray RL1 may be divided into two splitting light ray I1 and splitting light ray 12. The direction of a splitting light ray I1 is parallel to the X-axis, and the direction of the splitting light ray 12 is parallel to the Y-axis. The two splitting light ray I1 and splitting light ray 12 have the same light bands as the reflective light ray RL1.

In some embodiments, the angle of the reflective surface 131R of the beam splitter 131 may be adjusted according to the light pathway of the reflective light ray RL1. For example, the included angle between the light pathway of the reflective light ray RL1 and the reflective surface 131R may be more than 45 degrees or less than 45 degrees.

The filter 141 and filter 142 may be disposed along the light pathways of the splitting light ray I1 and the splitting light ray 12 at the position before the splitting light ray I1 and the splitting light ray 12 enter the image sensor 151 and the image sensor 152. The filter 141 and the filter 142 are configured to filter the splitting light ray I1 and the splitting light ray 12 to a filtered reflective light ray RL2 and a filtered reflective light ray RL3. In this embodiment, the filters 141 and 142 are configured to filter out light rays of different bands, that is, the filtered reflective light rays RL2 and RL3 are light rays of different bands. In this embodiment, the splitting light ray passing through the filter is called the filtered reflective light ray.

Specifically, in this embodiment, the filter 141 and the image sensor 151 are respectively disposed on the light pathway of the splitting light ray I1 parallel to the X-axis, and the filter 141 is configured to filter the splitting light ray I1 into the filtered reflective light ray RL2. In this embodiment, the filter 141 is, for example, a red light optical filter, and the band of the filtered reflective light ray RL2 is, for example, 620 nm to 750 nm. The image sensor 151 receives the filtered reflective light ray RL2 to generates an imaging frame ImA.

In addition, the filter 142 and the image sensor 152 are respectively disposed on the light pathway of the splitting light ray 12 parallel to the Y-axis, and the filter 142 is configured to filter the splitting light ray 12 into the filtered reflective light ray RL3. In this embodiment, the filter 142 is, for example, a blue light optical filter, and the band of the filtered reflective light ray RL3 is, for example, 450 nm to 495 nm. The image sensor 152 receives the filtered reflective light ray RL3 and generates an imaging frame ImB.

The full width at half maximums of the filtered reflective light rays RL2 and RL3 may be no more than 40 nm, such as 30 nm, 20 nm, or 10 nm. In response to the full width at half maximum being small enough, the contrast ratio that clearly shows specific defects is mapped more accurately, and the noise of the band with poor contrast ratio is reduced, so as to improve the image quality of the imaging frames ImA and ImB.

In this embodiment, the difference in center wavelengths between the band of the filtered reflective light ray RL2 (e.g., 620 nm to 750 nm) and the band of the filtered reflective light ray RL3 (e.g., 450 nm to 495 nm) is more than 50 nm. In response to a large difference in the center wavelengths between the filtered reflective light rays RL2 and RL3, the spectra of the filtered reflective light ray RL2 and the filtered reflective light ray RL3 have a wider coverage range, which increases the opportunity of clearing showing specific topographies in the imaging frame ImA and/or the imaging frame ImB (i.e., having better contrast ratio in one of the imaging frames). In addition, the full width at half maximum (FWHM) of the filtered reflective light ray RL2 and the filtered reflective light ray RL3 may be different or the same.

In some embodiments, the filters 141 and 142 may include, for example, color filters, optical bandpass filters. IR cut filters. IRpass filters, or UV Filters. The image sensor may include, for example, a charge couple device (CCD) or a complementary metal-oxide-semiconductor (CMOS), but the disclosure is not limited thereto.

It should be noted that the observation surfaces of the sample to be tested 111 are, for example, different parts on the outer surface of the sample to be tested 111. Or, if the structure of the surface of the sample to be tested 111 is transparent, one or more observation surfaces may also be the surface of the internal structure of the sample to be tested 111.

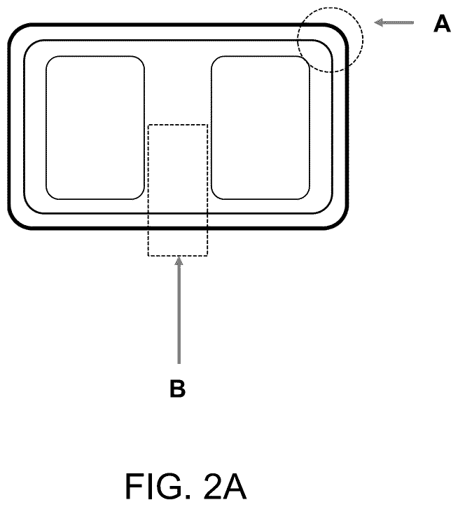

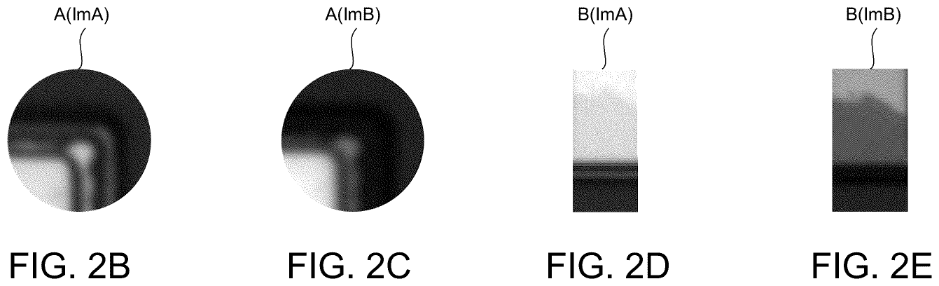

Continuing to illustrate with FIG. 1. FIG. 2A is a schematic top view of a sample to be tested, and FIG. 2B and FIG. 2C are microscope images of position A captured by the image sensor 151 and the image sensor 152 respectively. More specifically, FIG. 2B and FIG. 2C are imaging frame A (ImA) and imaging frame B (ImB) obtained from the position A in FIG. 2A. FIG. 2D and FIG. 2E are imaging frame A (ImA) and imaging frame B (ImB) obtained from position B in FIG. 2A.

Comparing FIG. 2B and FIG. 2C, imaging frame A (ImA) and imaging frame B (ImB) show different contrast ratio at the position A. Specifically. FIG. 2B has a higher contrast ratio at position A. In addition, comparing FIG. 2D and FIG. 2E, imaging frame A (ImA) and imaging frame B (ImB) show different contrast ratios at the position B. Specifically, FIG. 2E has a higher contrast ratio at the position B, which shows clearer topographic features.

In other words, the imaging frame A (ImA) obtained by the filtered reflective light ray RL2 is suitable for determining whether the position A meets a standard. The imaging frame B (ImB) obtained by the filtered reflective light ray RL3 is suitable for determining whether the position B meets the standard. Furthermore, according to different bands of the inspection light ray (i.e., the filtered reflective light ray RL2 and the filtered reflective light ray RL3), it may be determined whether the target features of the sample to be tested corresponding to the position A and the position B meet the standard. Compared with conventional wafer defect inspection apparatus, which requires the replacement of light sources of different wavelengths for inspection, the wafer defect inspection apparatus 100 of this embodiment obtains the imaging frame ImA and the imaging frame ImB of different bands through a single inspection, which may effectively save time and improve inspection efficiency.

In addition, contrast ratio refers to the ratio of brightness of the brightest and darkest two pixels in the imaging frame. Thus, the position A and the position B refer to image spots of each of the imaging frame ImA and the imaging frame ImB including multiple pixels. The contrast ratios of the imaging frame ImA and the imaging frame ImB are also obtained by calculating the ratio of brightness of two pixels in each of the image spots.

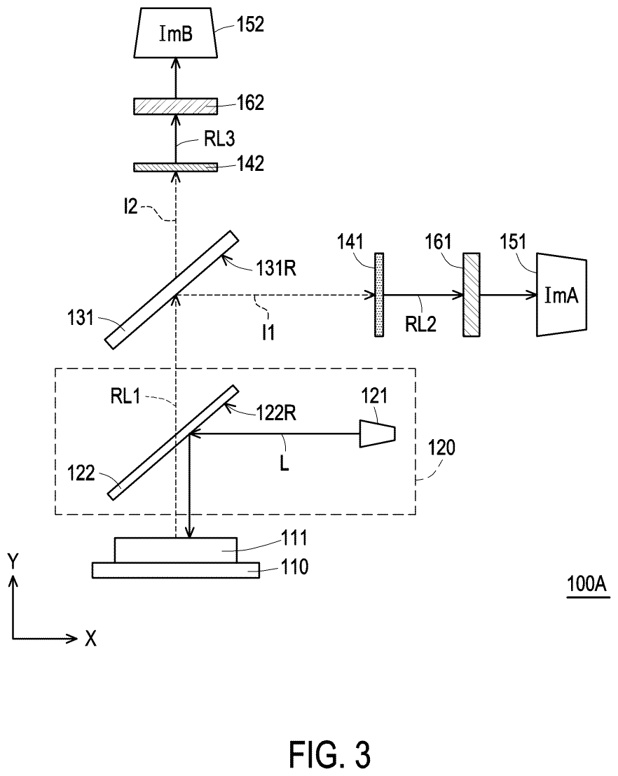

FIG. 3 is a schematic view of a wafer defect inspection apparatus according to another embodiment of the disclosure. Referring to FIG. 3, the wafer defect inspection apparatus 100A of this embodiment is similar to the wafer defect inspection apparatus 100 of FIG. 1. The difference between the two is that the wafer defect inspection apparatus 100A of this embodiment further includes dimming members 161 and 162 capable of adjusting the intensity of the light ray.

The dimming member 161 is disposed between the image sensor 151 and the filter 141, and the dimming member 162 is disposed between the image sensor 152 and the filter 142. The dimming member 161 and the dimming member 162 may respectively reduce the light intensity of the filtered reflective light ray RL2 and the filtered reflective light ray RL3 emitted from the filter 141 and the filter 142, so as to control the amount of light entering the image sensor 151 and the image sensor 152, thereby generating the imaging frame ImA and the imaging frame ImB suitable for automatic inspection.

In some embodiments, the dimming members 161 and 162 may include neutral density filters (ND), graduated neutral density filters (GND), or variable neutral density filters (VND).

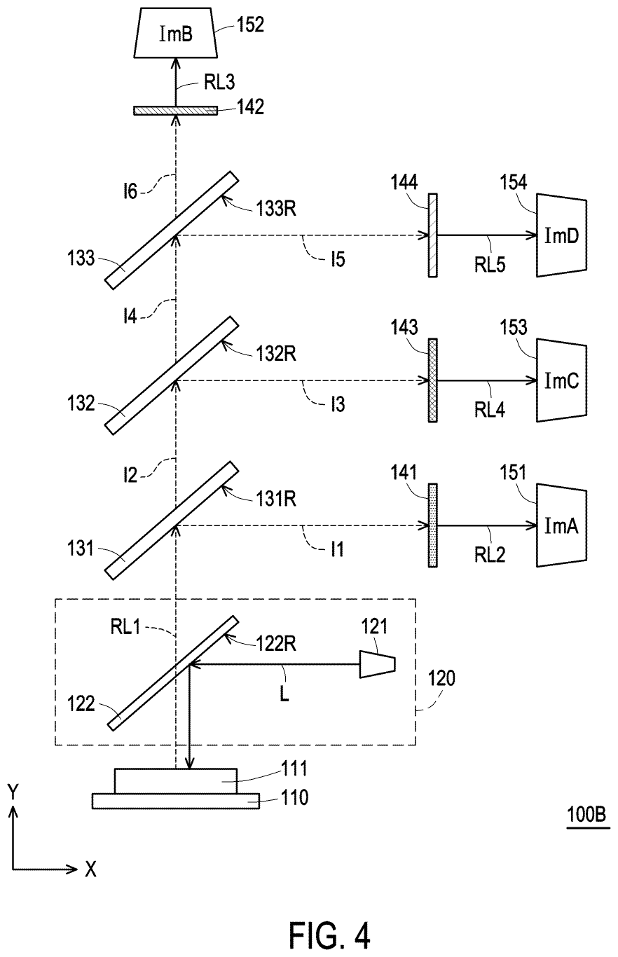

In some embodiments, the image sensors 151 and 152 may have different focal lengths. For example, the image sensor corresponding to the splitting light ray with a longer band has a focal length longer than another image sensor corresponding to the splitting light ray with a shorter band. Specifically, for example, in the embodiment of FIG. 4, the reflective light ray RL1 passes through the beam splitters 131, 132, and 133 respectively. The image sensor 152 receives the filtered reflective light ray RL3 corresponding to a splitting light ray 16. Under such configuration, the splitting light ray 16 may be a band with a longer wavelength, and the image sensor 152 also has a longer focal length than the other image sensors 151, 153, and 154. In this way, since the splitting light ray 16 has characteristics of longer propagation distance and lower attenuation in the beam splitters 131, 132, and 133, it is suitable to be disposed corresponding to the image sensor 152 with a longer light pathway. In addition, since the heights of the observation surfaces of the sample to be tested 111 may be different, even though the lengths of the light pathways of the image sensor 151 and the image sensor 152 in FIG. 3 may be the same, they may still focus on the observation surfaces with different focal lengths respectively to obtain clear image.

FIG. 4 is a schematic view of a wafer defect inspection apparatus according to another embodiment of the disclosure. Referring to FIG. 4, the wafer defect inspection apparatus 100B of this embodiment is similar to the wafer defect inspection apparatus 100 in FIG. 1. The difference between the two is that the wafer defect inspection apparatus 100B of this embodiment further includes beam splitters 132 and 133, filters 143 and 144, and image sensors 153 and 154.

The beam splitters 131, 132, and 133 are sequentially disposed on a side of the pellicle mirror 122 opposite to the carrier base 110. In this embodiment, the reflective light ray RL1 is directed to the beam splitter 131 and is split into two splitting light rays I1 and I2. The splitting light ray I1 is the part of the reflective light ray RL1 reflected by the reflective surface 131R, while the splitting light ray 12 is the part of the reflective light ray RL1 that passes through the beam splitter 131.

The splitting light ray 12 parallel to the Y-axis is directed to the beam splitter 132 and is split into two splitting light rays 13 and 14. The splitting light ray 13 is the part of the splitting light ray 12 reflected by the reflective surface 132R, while the splitting light ray 14 is the part of the splitting light ray 12 that passes through the beam splitter 132. The direction of the splitting light ray 13 is parallel to the X-axis, while the direction of the splitting light ray 14 is parallel to the Y-axis. The two splitting light rays have the same light band as the reflective light ray RL1.

The filter 143 and the image sensor 153 are respectively disposed on the light pathway of the splitting light ray 13 parallel to the X-axis, and the filter 143 is configured to filter the splitting light ray 13 into a filtered reflective light ray RL4. In this embodiment, the band of the filtered reflective light ray RL4 is, for example, 570 nm to 590 nm. The image sensor 153 receives the filtered reflective light ray RL4 to generate an imaging frame ImC.

The splitting light ray 14 parallel to the Y-axis is directed to the beam splitter 133 and is split into two splitting light rays 15 and 16. The splitting light ray 15 is the part of the splitting light ray 14 reflected by the reflective surface 133R, while the splitting light ray 16 is the part of the splitting light ray 14 that passes through the beam splitter 133. The direction of the splitting light ray 15 is parallel to the X-axis, while the direction of the splitting light ray 16 is parallel to the Y-axis. The two splitting light rays 15 and 16 have the same light band as the reflective light ray RL1.

The filter 144 and the image sensor 154 are respectively disposed on the light pathway of the splitting light ray 15 parallel to the X-axis, and the filter 144 is configured to filter the splitting light ray 15 into a filtered reflective light ray RL5. In this embodiment, the band of the filtered reflective light ray RL5 is, for example, 495 nm to 570 nm. The image sensor 154 receives the filtered reflective light ray RL5 to generate an imaging frame ImD.

In this embodiment, the bands of the filtered reflective light rays RL2, RL3, RL4, and RL5 are different, which makes the imaging frames ImA. ImB. ImC, and ImD have different performances in contrast ratio. Users may choose the position that is clearer on the imaging frames ImA, ImB, ImC, and ImD according to different performances in contrast ratio.

It is worth mentioning that, in some embodiments, the beam splitters 131, 132, and 133 may have different reflectivity.

For example, the beam splitters 131, 132, and 133 may be arranged in sequence along a light pathway where the reflective light ray passes through the pellicle mirror 122. Reflectivity of the beam splitters 131, 132, and 133 increments along the light pathway where the reflective light ray RL1 passes through the pellicle mirror 122.

For example, in response to the reflectivity of the pellicle mirror 122 being ½, the reflective light ray RL1 only has 50% of the original light intensity when passing through the pellicle mirror 122. At this time, assuming that the reflectivity of the beam splitter 131 is ¼, the reflectivity of the beam splitter 132 is ⅓, and the reflectivity of the beam splitter 133 is ½, the reflective light ray RL1 with a light intensity of 50% is split by the beam splitter 131 into two splitting light ray I1 and splitting light ray 12 with light intensity of 12.5% and 37.5%. The reflective light ray 12 with a light intensity of 37.5% is further split by the beam splitter 132 into two splitting light ray 13 and splitting light ray 14 with a light intensity of 12.5% and 25%. The reflective light ray 14 with a light intensity of 25% is further split by the beam splitter 133 into two splitting light ray 15 and splitting light ray 16 with a light intensity of 12.5%, respectively.

Such a design makes the light intensity of the splitting light rays I1, I3, I5, and I6 the same or close to each other (12.5% in this example), and then the light intensity of the filtered reflective light rays RL2, RL4, RL5, and RL3 are also close to each other. In this way, the generated imaging frames ImA. ImB. ImC, and ImD may have relatively consistent brightness, which is convenient for interpretation.

To sum up, the wafer defect inspection apparatus of the disclosure splits and filters the reflective light ray reflected by a sample to be tested into splitting light rays of different bands by disposing a beam splitter and a filter. The splitting light rays are received by multiple image sensors, and multiple imaging frames may be generated synchronously. Since the imaging frames have different contrast ratios at corresponding positions, an imaging frame with higher contrast ratio may be used to determine whether there is a defect in this position. Compared with conventional wafer defect inspection apparatus, which requires the replacement of light sources of different wavelengths for inspection, the wafer defect inspection apparatus of the disclosure obtains multiple imaging frames of different bands through a single inspection, which may effectively save time and improve inspection efficiency.

The embodiments described hereinbefore are chosen and described in order to best explain the principles of the invention and its best mode practical application. It is not intended to be exhaustive to limit the invention to the precise form or to the exemplary embodiments disclosed. Namely, persons skilled in the art are enabled to understand the invention through various embodiments with various modifications as are suited to the particular use or implementation contemplated. It is intended that the scope of the invention be defined by the claims appended hereto and their equivalents in which all terms are meant in their broadest reasonable sense unless otherwise indicated. Any of the embodiments or any of the claims of the present invention does not need to achieve all of the objects, advantages or features disclosed by the present invention. Moreover, the abstract and the headings are merely used to aid in searches of patent files and are not intended to limit the scope of the claims of the present invention. In addition, the terms “first.” “second” and the like mentioned in the specification or the claims are used only to name the elements or to distinguish different embodiments or scopes and are not intended to limit the upper or lower limit of the number of the elements.

What is claimed is:

1. A wafer defect inspection apparatus, adapted for inspecting a sample to be tested, comprising:
a carrier base adapted for carrying the sample to be tested;
a light source module, disposed corresponding to the carrier base, comprising:
an illuminating unit, configured to emit an inspection light ray; and
a pellicle mirror, comprising a reflective surface, wherein the reflective surface faces the illuminating unit and the carrier base, and the reflective surface is adapted for reflecting the inspection light ray to the sample to be tested, so that a reflective light ray formed by reflecting the inspection light ray reflected by the sample to be tested passes through the pellicle mirror;
at least one beam splitter, disposed on one side of the pellicle mirror opposite to the carrier base and configured to receive and split the reflective light ray passing through the pellicle mirror into a plurality of splitting light rays;
a plurality of filters, respectively disposed on light pathways of the splitting light rays, wherein the filters are configured to be passed through by different bands corresponding to the splitting light rays; and
a plurality of image sensors, disposed on the light pathways of the splitting light rays and respectively located on one side of one of the filters opposite to the beam splitter, wherein each of the image sensors receives one of the splitting light rays to generate an imaging frame, and two corresponding positions in any two of the imaging frames have two different contrast ratios.

2. The wafer defect inspection apparatus according to claim 1, wherein the inspection light ray incident on the pellicle mirror has a same band as the reflective light ray passing through the pellicle mirror.

3. The wafer defect inspection apparatus according to claim 1, wherein a full width at half maximum (FWHM) of each of the bands is less than 40 nanometers.

4. The wafer defect inspection apparatus according to claim 1, wherein the bands have different full width at half maximums (FWHMs).

5. The wafer defect inspection apparatus according to claim 1, wherein a difference between two central wavelengths of any two of the bands is more than 50 nanometers.

6. The wafer defect inspection apparatus according to claim 1, wherein the image sensors have different focal lengths.

7. The wafer defect inspection apparatus according to claim 6, wherein one of the image sensors corresponding to a splitting light ray with a longer band has a focal length longer than another image sensor corresponding to a splitting light ray with a shorter band.

8. The wafer defect inspection apparatus according to claim 1, wherein the inspection light ray and the reflective light ray incident on the sample to be tested by the pellicle mirror are two parallel light rays.

9. The wafer defect inspection apparatus according to claim 1, wherein the at least one beam splitter comprises a plurality of beam splitters arranged in sequence along a light pathway where the reflective light ray passes through the pellicle mirror, and reflectivity of the beam splitters increments along the light pathway where the reflective light ray passes through the pellicle mirror.

10. The wafer defect inspection apparatus according to claim 1, further comprising at least one dimming member disposed between at least one of the image sensors and a corresponding filter.
